(19) United States
(12) Patent Application Publication
(10) Pub. No.: US 2006/0031825 A1
(43) Pub. Date: Feb. 9, 2006

(54) Method, device and system for providing additional information related to the contents of a radio broadcast to terminal devices

(76) Inventor: Michael Mulligan, Cullionboy (IE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/528,459

(22) PCT Filed: Sep. 20, 2002
(86) PCT No.: PCT/IB02/03890

§ 371 Date: Mar. 18, 2005

(51) Int. Cl. G06F 9/44

(52) U.S. Cl. 717/168

(57) ABSTRACT

A radio broadcast system using a second communication channel provides an interactive functionality to allow a user to know what song or piece of music is playing on the first, radio channel and possibly other details about what is being listened to. A data transmission from the broadcast station is received by a server with additional information about the content of the first channel, and after the server determines mobile terminal devices to be updated with the additional information, it generates updating messages comprising the additional information, and updates the information to the determined terminal devices via a wireless communication network. The updated information is then received by a given terminal device and displayed on a display of the device.

The invention is related to the field of traditional radio broadcast. The invention is more specifically related to radio broadcast having an interactive messaging service. Most specifically the invention is related to a radio broadcast system using a second communication channel to provide an interactive functionality. The invention is designed to enhance the listening comfort of the user. The invention allows the user to know what song or piece is playing on the radio channel and possibly other details about what is being listened to.

A person listening to a radio broadcast often has need for additional information about current programs, e.g. the song playing in the radio. There are some known methods of providing this:
The original solution is that the radio DJ recites the name of the music track and maybe the artist at the end of a track
Different radio stations are able to provide information via “radio data system” (RDS) known from car radios
Different internet radio stations are able to provide information about their current show through their home page
Nokia™ has published a collaboration with Capital Radio™ (London) using an interaction and information service via SMS

The first two classical solutions do not provide an interactive radio, as there is only a one-way connection from the radio station to the receiver. The two classical solutions have the drawback that certain and maybe useful options cannot be used in a one-track-only environment. The main drawback for the DJ is that he does not always tell the name of the piece and of the artist of a music track. The main advantage is that any user can hear the announcements of a DJ, without the need for special equipment

The main drawback of the Radio Data System is that the standard RDS radio display is too small to provide a sufficient space to display the name of the radio station, the artist and the name of the actual track. The information is provided in a newscaster-fashion on a very small display. Especially in car radio applications, the reading of the newscaster consumes time and distracts the attention of the driver from the traffic while driving. Another drawback is that actually only a few radios are equipped with an RDS system.

Different Internet radio stations are able to provide information of their current show through their home page. The use of the Internet includes the use of a two way communication medium, which in turn provides a fully-fledged interactivity or adds interactive features to a conventional radio station. With the use of an additional two-way communication channel, interactive features are added to the functionality of a conventional radio station. The main drawback of this solution is that the user needs a computer and has to be online which is in fact time, energy and money consuming.

The SMS (Short Message Service) based information service of Nokia™ in collaboration with Capital Radio™ offers a conventional radio station with an interactive component by using SM (Short Messages) as an additional two-way communication channel, to transport additional information between the listener and the radio station and vice versa Therefore, a user can interact with the radio station by sending an SM to the radio station. The additional information can comprise requested additional information of an actual track, a notification of another person when a certain track is going to be broadcast on a certain radio station, or the transfer of a ringing tone for a mobile telephone including the tune or the chorus of the track actually broadcast.

The SMS (Short Message Service) based information service has the drawback that the user has to request the information by sending an SM to the radio station, which is expensive. Another disadvantage is the limited input device (the ITU-T keypad) as the SMS has to be typed first before being sent. The short message service is only capable of delivering one single item of information.

The SMS based information service has the drawback in that the user needs a possibility to send an SM to the radio station. Usually this is done by means of a mobile telephone, which includes the drawbacks that the user may not be certain which radio station he is actually listening to, and to which radio station the SM is to be sent. This problem can be avoided by a classical broadcast radio facility integrated in a mobile phone terminal such as in case of Nokia 5510™, 6510™, 6590™, 6610™, 7210™ and 8310™.

All the above approaches have in common that they are not suitable to provide an optimized data transfer from a radio station to a user.

Therefore, it is desirable to have an optimized data exchange between a user device and a radio station without a waste of network resources.

It is further desirable to have a system that is easy to use and in which an incorrect operation is almost excluded and impossible.

It is further desirable to have a system capable of selectively delivering additional information to a certain user.

According to a first aspect of the present invention a method is provided for delivering additional information data related to the contents of an actual radio broadcast from a radio station to terminal devices, wherein the terminal devices are connected to a server in a wireless communication network. The method may be used in a server in a wireless network and comprises the reception of a data transmission from said radio station. Said data transmission comprises additional information data related to the actual contents of a radio broadcast from said radio station. The additional information data can comprise information such as the name of artist, composer or the name of a piece of music, the author and the name of a radio play, and other background information. The information data can be plain text, as e.g. in the case of RDS/SMS compatible information, but can also comprise graphics, pictures and advertisements. Another possibility is to use a URL link. This can be embodied in a later release of presence in the dynamic phonebook. This opens up the possibility of interaction with a web browser if even more info is required. The additional information can even comprise a small acoustic intro of the song, or, an animated picture sequence like used in the magic latern, or even a small video sequence. After the reception of the transmission, the server can store or update the information in the server.

Following the reception of said transmission, the server determines mobile terminal devices to be supplied or updated with said additional information. This can be embodied by means of a relation table comprising a list of all terminal devices to be delivered with said additional information. Then, the server generates an updating message for each of said determined terminal devices comprising said additional information. The server can also generate a single updating message for all or groups of the determined terminal devices comprising said additional information data, and adapt only the respective addresses. The size, the format, and even the information contents of the message may be custom-generated for each of said determined terminal devices in dependence of the properties of the destination device or information stored in the relation table. The messages can be generated in dependence of a transfer protocol used in said wireless communication network. Finally, the server sends said generated messages to each of said terminal devices via said wireless communication network.

It is to be noted that the single transmission needs not to be requested or confirmed, but can be received as in case of a one-way pager. The terminal devices may confirm the transferred message. Therefore, it is possible that the server further receives a message from the wireless network or a terminal device to stop the transmission. It may be noted that the time required to deliver the message to the terminal device should only require a few seconds, and should not exceed a minute. A fast delivery of the messages is required as the actual radio broadcast, e.g. a piece of music has an average duration of a few minutes, and in case of longer delivery time the additional information is no longer up to date and invalid concerning the contents of the actual radio broadcast transmission.

In one example embodiment, said server uses a presence database for determining said mobile terminal devices to be supplied with said additional information. A presence database is e.g. known from messaging programs in the Internet informing a user about the other selected users being online or not. One aspect of the invention is that of a presence feature. Presence has many definitions. The one used here may be: “Presence” is a dynamic (variable) profile of a user, visible to others and used to represent oneself, share information and control services”. This embodiment of the invention proposes an innovative use for presence, which goes beyond the standard definition. This functionality can best be compared with internet messaging programs comprising “buddy lists” indicating if certain persons are online or not.

In this embodiment of the present invention, this feature is extended to more and more specific information, such like the title of the actual track, the title of the CD or the name of the artist. Instead of presence entries such as “I'm here” or “I'm happy” the Radio station provides the information “(I'm playing) U2—Beautiful Day” as the presence entry of the radio station. In a second step, this information is forwarded to all terminal devices having subscribed to this information, or listed the radio station in their “buddy list”. So a continuous and actual data transfer from the radio to the terminal devices via a simple server using standard components can be achieved, without the need to start repeated information transfer from the user to the radio station to request this information.

In another example embodiment, the method further comprises a determination, whether or not said additional information received from said radio station has changed, and generating said messages only, if said information has changed. By using a simple comparing step of the received information, the server can suppress the generation of redundant messages and save network resources of said wireless network.

In yet another example embodiment, the method further comprises receiving a transmission from a terminal device indicating that said mobile terminal device is to be supplied with said additional information. Following that, a message comprising said additional information for said terminal device is generated and sent to said terminal device via said wireless communication network.

By receiving the transmission from the terminal device, the server can process or change the presence status of said terminal device, e.g. by changing entries in a relation table to recognize this device as an addressee for a message containing said additional information. By the following two steps, the server generates and delivers a message to said device comprising the actual additional information. This procedure guarantees that a user receives the actual information immediately, when subscribing to the information service. This procedure describes the transmission of the first message to a terminal device with is then updated by the following messages form the server.

In yet another example embodiment of the present invention the method further comprises the reception of a transmission indicating that said mobile terminal device is no longer to be supplied with said additional information. This transmission can be originated form the device itself, to cross off or delete the subscription to said service. In another case this information can be originated from a server of said wireless network indicating that the terminal device is not longer connected to said network.

According to another aspect of the present invention, a method for displaying additional information data related to the actual contents of a radio broadcast from a radio station is provided. In this method said additional information is received from a server via a wireless communication network, and comprises: receiving said radio broadcast from said radio station via a wireless broadcast channel, receiving a message comprising said additional information data from a server connected to said wireless communication network and displaying said additional information from said received message.

The received messages can be delivered form a push-type service, by generating the messages, as is described in the preceding description. The method can further process data contained in said message for displaying said data The received data can be stored and be updated with each newly received message. An updating process can comprise storing an actual data transmission and deleting a previous data transmission. The storage can contain a single entry or a number of the last 2, 3, 5 or 10 entries, so a user can look at the title of a song heard a few minutes ago. The memory can be implemented as a first-in-first-out memory with a selectable storage depth. The user can transfer the additional information to a “task memory” to remind him to buy the CD from which he heard a song.

With this solution, the user would only have to subscribe once to the radio station. The track information for the radio station would then be updated automatically in the user presence list, which is a list at the user device indicating the presence of other user and the radio station. In the case of Nokia™ terminals, this information can be updated in the phonebook. In addition, the information is not just limited to text, but can also comprise graphics and other media types. This leaves an opportunity for extra information or branding on behalf of the radio station. This embodiment of the present invention proposes to treat a radio station as “typical presence presentity”. In this way, a user can subscribe to the presence of the radio station in the standard way. The difference is that the radio station would use different presence attributes from a normal user. Instead of typical presence attributes such as availability (online/offline) and mood (happy/sad) the radio station would use an attribute, which has e.g. the value of the current track playing on the radio.

In another example embodiment of the present invention, the method further comprises processing said additional information of said message for display and/or for storage. This processing can be used to compress data to reduce the required storage space. This processing can for example be used to generate animated display content, to adapt colored graphics information to a black and white display.

In yet another example embodiment of the present invention the method further comprises transmitting a message to a server in said wireless communication network to initiate the transmission of a message comprising said additional information related to the contents of said received radio broadcast. This can be embodied by subscribing to a presence database, a presence notification service and the like.

In another example embodiment the method further determines a name of said radio station transmitting said radio broadcast A table allocating each frequency to a radio station entry can perform this determination. An RDS system can determine the radio station automatically, by using an inaudible component in the radio broadcast transmission to transfer the name of the radio station to the user terminal. In a more sophisticated embodiment of the invention, the terminal device itself can automatically generate a subscription message and join the additional information service after user confirmation.

In yet another example embodiment of the present invention, the method further comprises the displaying the name of said determined radio station, and said received additional information together on a display. Both information can be displayed in a “split screen” fashion, and in a composed graphic comprising information received from a radio module and a wireless network module.

According to yet another aspect of the invention, a software tool is provided comprising program code means stored on a computer readable medium for carrying out the method for providing additional information related to the actual contents of a radio broadcast from a radio station to a terminal device of the preceding description when said software tool is run on a mobile terminal or a network device.

According to another aspect of the present invention, a computer program product for carrying out the method for providing additional information related to the actual contents of a radio broadcast from a radio station to a terminal device of the preceding description is provided, which comprises downloadable program code means for performing all of the steps of the preceding description when said program is run on a mobile terminal or a network device.

According to yet another aspect of the invention, a computer program product is provided comprising program code means stored on a computer readable medium for carrying out the method for providing additional information related to the actual contents of a radio broadcast from a radio station to a terminal device of the preceding description when said program product is run on a mobile terminal or a network device.

According to another example embodiment, a network server for providing additional information related to the contents of a radio broadcast from a radio station to connected terminal devices is provided. The network server comprises a network module for receiving transmissions comprising said additional information from said radio station. The network module can connect the server to a wired or a wireless network. The network server comprises a database for storing indications of said terminal devices to be supplied with said additional information This database can be embodied as a presence database, to provide a presence server functionality to the server. A controller is connected to said network module, for processing said received transmissions, and is connected to said database for receiving indications of said terminal devices to be supplied with said additional information and for generating messages and updating messages for said determined terminal devices. The controller can be configured to operate the server as a presence server. The server further comprises a wireless network module for sending said generated messages to said terminal devices.

The network module and the wireless network module can be integrated in a single device if the connection to the radio station is also implemented as a wireless connection. The implementation involves integrating a presence server and the infrastructure of the radio station. This integration can be done using the OMA (Open Mobile Architecture) interface. This entails that a presence service operator (e.g. mobile operator) exposes the interface to the radio station. This can be done via SOAP/HTTP so that this can be switched over the Internet.

In yet another example embodiment, the present invention provides a mobile terminal device, that is capable of displaying additional information related to the actual contents of a radio broadcast from a radio station. The mobile terminal comprises a radio module, a wireless network module, a controller, a memory and a display module. The radio module is for receiving said radio broadcast. The wireless network module is used for receiving messages and updating messages comprising said additional information. Said controller is for processing said received messages and updating messages connected to said wireless network module. Said memory is connected to said controller for storing and updating said additional information. The display module is connected to said controller for displaying said additional and updated additional information. Such a terminal device can be presence enabled, meaning that the terminal device can run a presence software on said controller to receive and handle messages indicative of the presence state of other terminals in said wireless network.

In another example embodiment of the present invention, said radio module is connected to said controller, and said radio module is connected to said wireless network module to transfer data from said radio module to said wireless network module. The connection can be implemented as a direct connection to said wireless network module or as an indirect connection via said controller module. In contrast to the above embodiment, wherein said radio module can be implemented as a separate module within said mobile terminal device, a data exchange between the radio module and the wireless network module is enabled. This connection can be used to control the radio directly from the controller. Another advantage of this connection is that a user can use a single interface to operate all the functions of the radio, the wireless network module and the other components of the mobile terminal device.

In another example embodiment, said radio module comprises a radio data system (RDS) module for determining said radio station. By using an RDS radio, a user can easily recognize the radio station he is listening to without the need to remember on which frequency a certain radio station operates. The RDS radio in connection with the network module can be used to automatically generate the message to subscribe to the notification service, or can be used to automatically configure the presence service.

In another example embodiment, the mobile terminal device further comprises a cellular telephone module connected to said controller. The cellular phone module enables the device to provide a multipurpose functionality to a user. With such a multi functional device a user needs only to carry a single device instead of a number of different devices to listen to radio broadcast, hear music, access a wireless network and to phone other people.

In yet another example embodiment the mobile terminal device further comprises a television module being connected to said controller. By incorporating a TV in the mobile terminal, a user can utilize the advantageous features of a wireless network connection to be provided with additional information related to the actual TV program. This can be especially useful e.g. for the transfer of additional information such as subtitles and actual news.

Further, the invention in another embodiment comprises a system for providing broadcast data, said system comprising

a broadcast station for sending a broadcast and for providing additional information data related to the contents of said broadcast;

a network server for receiving said additional information data, said additional information data to be supplied to at least one mobile terminal device, said network server comprising:
a network module for receiving said additional information data from said broadcast station,
a database for storing indications of said at least one mobile terminal devices to be updated with said additional information data,
a controller being connected to said network module, for processing said additional information data, and being connected to said database for receiving said indications of said at least one mobile terminal device and for determining at least one mobile terminal device to be supplied with said additional information data, and
a wireless network module connected to said controller for updating said additional information data with said determined mobile terminal device, and

a mobile terminal device capable of displaying said additional information data, comprising:
a radio module for receiving said broadcast,
a wireless network module for receiving said additional information data,
a controller for processing said received additional information data, said controller being connected to said wireless network module,
a memory connected to said controller for storing said processed additional information data, and
a display module connected to said controller for displaying said processed additional information data.

The system in accordance with the present invention comprises the broadcast station, the network server and the mobile terminal device.

It is to be noted that the mobile terminal device can comprise additional modules such as a media player/recorder, a digital camera and the like.

In the following, the invention will be described in detail by referring to the enclosed drawings in which:

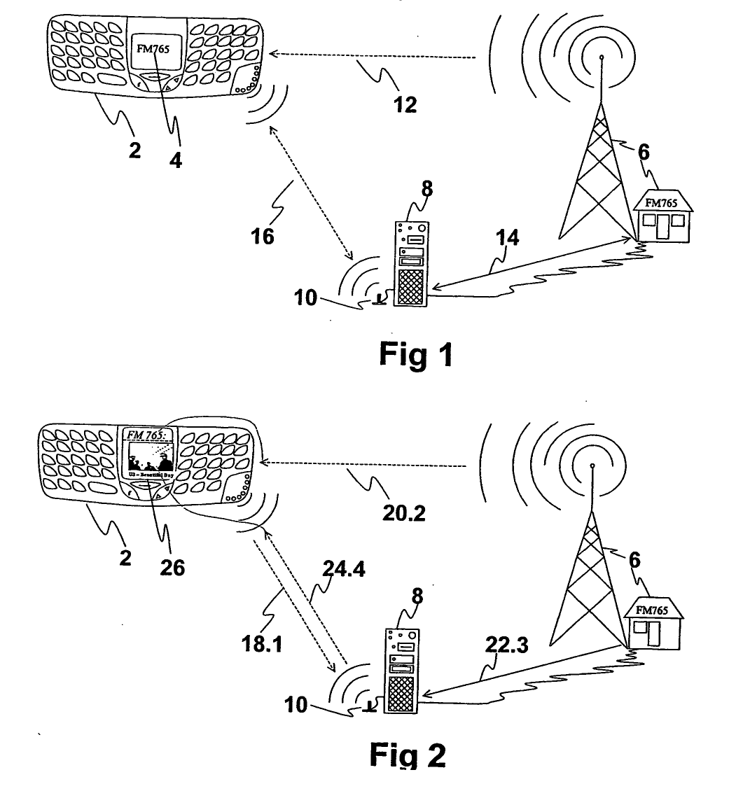

FIG. 1 is a graphic showing the basic components of system architecture for executing the method of the present invention.

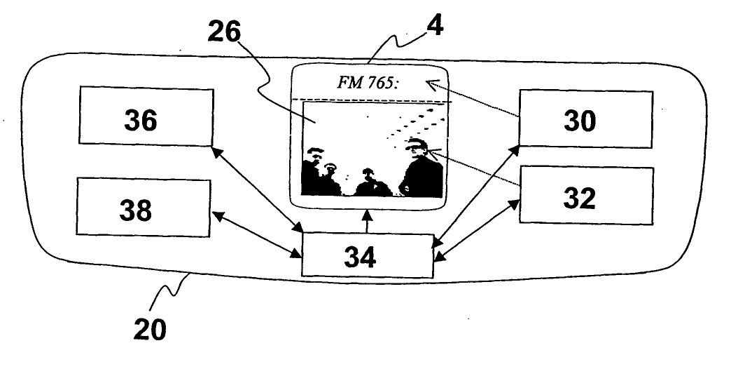

FIG. 2 depicts the architecture of FIG. 1, with indications of the data transfers necessary for executing the method according to the invention.

FIG. 3 is depicts the architecture of a terminal device according to one embodiment of the present invention.

FIG. 1 shows a high level outline of the architecture of the system. There are three basic elements, the user terminal 2, the Presence Server 8 and the radio station infrastucture 6. Other elements are omitted for simplicity. The protocol 16 between the terminal 2 and the Presence Server 8 is the Wireless Village Client Server Protocol (CSP). The protocol 16 between the terminal 2 and the Presence Server 8 can also be embodied as SIP SIMPLE. The protocol 14 between the Presence Server 8 and the radio station infrastructure 6 is the Presence Server Web Services interface. In the figure, the terminal 2 comprises a display 4. The Presence Server 8 is connected to a Wireless Village transmission station 10. The radio station infrastructure 6 is transmitting a radio broadcast 12. The display 4 of the terminal is depicting the name of radio station that is actually received. In as classical multi purpose device this can be achieved by a RDS or a manually generated frequency/Radio Station correlation, as in the case of phone book entries of a mobile phone. To implement the present invention a connection 14 between the radio station infrastructure 6 and the Presence Server 8 of a wireless network is required. The wireless network is necessary to keep up the mobility of the mobile multi-purpose terminal device 2.

FIG. 2 shows a simple use case of a radio station 6 playing a track 20.1 and then updating the track info 22.2, 24.4 e.g. in the subscribers phonebook. The user subscribes to a track information service by transferring or notifying (18.3) the server 8 to subscribe to a presence service of the radio station 6. With the broadcast of a new track 20.1, the radio station 6 transmits changed presence information 22.2 to the presence server 8. Following that, the presence server determines all terminal devices having subscribed to this service and sends messages 24.4 to all terminal devices containing additional information of the actual track. The track info is updated via the Wireless Village transmission station 10 using the Wireless Village free text attribute. The track info also updates the logo attribute in the mobile terminal device 2 to place a picture 26 of the band playing.

The invention makes use of different aspects of presence. Between the user terminal and the Presence Server a client server presence protocol such as Wireless Village or SIP SIMPLE can be used. Between the radio station and the Presence Server, the Presence Server Web Service API (Application Protocol Interface) is used. This can be embodied as a proprietary interface, but can also be implemented as part of the OMA (Open Mobile Architecture) Web Services. In practice, the radio station simply updates its presence using the OMA API and the Client Server protocol ensures that this information is relayed to the user terminal.

This invention presents a way to provide additional information of the current radio show (or other broadcast) by the means that the radio station is the presentity in presence server. The listeners who want to add the radio station to their “buddy list”, “dynamic phonebook” etc. are able to check the radio station status when ever they want to. The radio station status comprises the actual track information and additional features. The status is updated to their terminals automatically as known from the SIP SIMPLE or Wireless Village protocol.

The present invention provides two major advantages: the amount of data pushed to the devices is reduced and requires only a minimum of network resources, and the invention can be implemented using only standard applications such as messaging systems, not requiring feedback.

In addition to the transfer of the additional information the wireless interface to the radio station via the server can be used to provide additional interactive features to:
Dedicate a track to a friend, who will be alerted to the dedication 15 minutes before the track is played on the radio station. Dedications can be accompanied with a text greeting from the sender.
Set an alert for himself to provide a reminder function not to miss a certain show on radio or TV.
Find out the name of both the last track and the track currently playing, along with the name of the artist, current price information for the CD at a local music store.
Select and download new tracks as ringtones directly from a server or the radio station using their mobile phone.
Additional services such as gig guides, news and alerts for on-air features are also envisaged.

The current invention improves earlier solutions in terms of usability and convenience. To give a comparison with the SMS based service, the user in that service has to send an individual SMS for each track he requests information about. Moreover, for each request the user has to type in his request as an SMS message. Then, the information returned is restricted to a text only format.

FIG. 3 is depicting the architecture of a terminal device according to one embodiment of the present invention. The terminal device 2 comprises a display 4, a controller 34 connected to the display. The controller 34 is further connected to a memory device 38, to a wireless network module 32, a broadcast receiver module 30 and to a telephone module 36. The controller 34 is also connected to a user interaction interfaces (not shown) such as keys, keypads, microphones loudspeakers and the like to control the modules 30 to 38. The centralized architecture of this embodiment enables the device to use only a single memory module 38 to store all the relevant data from the telephone 36, the wireless network 32 and the broadcast module 30. This enables the device 2 to simultaneously display data from the radio module 30 (i.e. the station name depicted in upper area of the display 4 indicated by a dotted arrow) and the additional information received via the wireless network module 32 (i.e. the picture 26 depicted in the lower area of the display 4 indicated by a dotted arrow). The present invention is not restricted to the above displayed architecture, but can be modified in different ways, to be extended with additional modules for receiving TV broadcasts, play and record media, digital cameras or video recorders and the like.

The usage of the invention is much easier than the one with SMS messages. Also compared to the Internet Radio systems it does not require a continuous data connection, which is a quite resource wasting method particularly in mobile solutions. The information is pushed to the terminal only when the presence information has changed.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus, the possibilities of implementing and using the invention are only restricted by the enclosed claims. Consequently, various options of implementing the invention as determined by the claims, including equivalent implementations, also belong to the scope of the invention.

1. Method for providing broadcast data comprising a broadcast being sent from a broadcast station and update additional information data related to said current radio broadcast, said broadcast data being provided to at least one mobile terminal device, said mobile terminal device being connected to a server in a wireless data network, said at least one mobile terminal device comprising components for receiving said broadcast from said at least one broadcast station and for receiving said update additional information data from said server, comprising:
receiving at the server said update additional information data of said current radio broadcast from said at least one broadcast station, via a network connection between said server and said radio station,
determining at least one mobile terminal device to be supplied with said update additional information data of said current radio broadcast, and
updating said update additional information data of said current radio broadcast with said at least one determined mobile terminal device via said wireless communication network.

2. Method according to claim 1, wherein said server uses a presence database for determining said at least one mobile terminal device to be updated with said update additional information data of said current radio broadcast.

3. Method according to claim 1, wherein said update additional information data of said current radio broadcast from said at least one broadcast station is received from at least one second server connected to said at least one broadcast station.

4. Method according to claim 1, wherein said broadcast station comprises one of said servers, wherein said update additional information data is received from a component within said broadcast station.

5. Method according to claim 1, further comprising determining whether said update additional information data of said current radio broadcast received from said broadcast station has changed, and updating said update additional information data only, if said update additional information data has changed.

6. Method according to claim 1, further comprising:
receiving a transmission from a mobile terminal device indicating that said mobile terminal device is to be supplied with said update additional information data,
determining said mobile terminal device is to be supplied with said update additional information data, and
sending said update additional information data of said current radio broadcast to said mobile terminal device via said wireless communication network.

7. Method according to claim 1, further comprising:
receiving a transmission indicating that said mobile terminal device is no longer to be updated with said update additional information data.

8. Method for receiving broadcast data in a mobile terminal device, said broadcast data comprising a broadcast being sent from at least one broadcast station and update additional information data related to said current radio broadcast, said mobile terminal device being connected to a server in a wireless data network, said at least one mobile terminal device comprising components for receiving said broadcast from said at least one broadcast station and for receiving said update additional information data from said server, comprising:
receiving said broadcast from said broadcast station via a wireless broadcast channel,
receiving said update additional information data of said current radio broadcast, from said server via said wireless communication network, and
updating said update additional information data of said current radio broadcast on said mobile terminal device.

9. Method according to claim 8, further comprising displaying said update additional information data of said current radio broadcast on said mobile terminal device.

10. Method according to claim 9, further comprising processing said update additional information data of said current radio broadcast for display.

11. Method according to claim 8, further comprising transmitting a message to a server in said wireless communication network to initiate transmission of said update additional information data related to contents of said currently received broadcast.

12. Method according to claim 8, further comprising determining a name of said broadcast station transmitting said broadcast.

13. Method according to claim 12, further comprising displaying the name of said determined broadcast station and said received update additional information data of said current radio broadcast together on a display.

14. Method for providing broadcast data comprising a broadcast being sent from a broadcast station and update additional information data related to said current radio broadcast to at least one mobile terminal device, said broadcast being available for said at least one mobile terminal device, and said update additional information data being available for said at least one mobile terminal device, said mobile terminal device being connected to a server in a wireless data network, said at least one mobile terminal device comprising components for receiving said broadcast from said at least one broadcast station and for receiving said update additional information data from said broadcast station via said server, comprising:
transmitting said broadcast from said at least one broadcast station to said at least one mobile terminal device,
transmitting said update additional information data of said current radio broadcast from said at least one broadcast station to said server, via a network connection between said server and said radio station,
determining at the server at least one mobile terminal device to be supplied with said update additional information data of said current radio broadcast,
updating said update additional information data of said current radio broadcast to said at least one determined mobile terminal device via said wireless communication network, and
displaying said broadcast and said update additional information data of said current radio broadcast on said mobile terminal device.

15. Software tool comprising program code means stored on a computer readable medium for carrying out the method of claim 8 when said software tool product is run on a mobile terminal.

16. Computer program product for providing update additional information data of a broadcast transmission via a network to a mobile terminal device, comprising loadable program code means for carrying out the steps of claim 1 when said program is run on network device.

17. Computer program product comprising program code means stored on a computer readable medium for carrying out the method of anyone of claim 8 when said program product is run on a mobile terminal.

18. Network server for providing update additional information data related to contents of at least one current radio broadcast from at least one broadcast station, said update additional information data to be supplied to at least one mobile terminal device, comprising:
a network module for receiving said update additional information data from said broadcast station via a network connection between said server and said radio station,
a database for storing indications of said at least one mobile terminal device to be updated with said update additional information data,
a controller being connected to said network module, for processing update additional information data, and connected to said database for receiving said indications of said at least one mobile terminal device and for determining at least one mobile terminal device to be supplied with said update additional information data, and
a wireless network module connected to said controller for updating said update additional information data to said determined mobile terminal device.

19. Mobile terminal device, capable of displaying update additional information data related to contents of a current radio broadcast received from a broadcast station, comprising:
a radio module for receiving said broadcast,
a wireless network module for receiving said update additional information data of said current radio broadcast,
a controller for processing said received update additional information data of said current radio broadcast, said controller being connected to said wireless network module,
a memory connected to said controller for storing said processed update additional information data of said current radio broadcast, and
a display module connected to said controller for displaying said processed update additional information data of said current radio broadcast.

20. Mobile terminal device according to claim 19, wherein said radio module is connected to said controller, and wherein said radio module is connected to said wireless network module to transfer data from said radio module to said wireless network module.

21. Mobile terminal device according to claim 19, wherein said radio module comprises a radio data system (RDS) module for determining said broadcast station.

22. Mobile terminal device according to anyone of claims 19 claim 19, further comprising a cellular telephone module being connected to said controller.

23. System for providing broadcast data comprising a broadcast station for sending a radio broadcast and for providing update additional information data related to contents of a current radio broadcast;
a network server for receiving said update additional information data, wherein said update additional information data is to be supplied to at least one mobile terminal device, said network server comprising:
a network module for receiving said update additional information data of said current radio broadcast from said broadcast station via a network connection between said server and said radio station,
a database for storing indications of said at least one mobile terminal device to be updated with said update additional information data,
a controller for being connected to said network module, for processing said update additional information data, and for being connected to said database for receiving said indications of said at least one mobile terminal device and for determining at least one mobile terminal device to be supplied with said update additional information data of said current radio broadcast, and
a wireless network module connected to said controller for updating said update additional information data to said determined mobile terminal device, and
a mobile terminal device capable of displaying said update additional information data of said current radio broadcast, comprising:
a radio module for receiving said current radio broadcast,
a wireless network module for receiving said update additional information data of said current radio broadcast,
a controller for processing said received update additional information data of said current radio broadcast, said controller being connected to said wireless network module,
a memory connected to said controller for storing said processed update additional information data of said current radio broadcast, and
a display module connected to said controller for displaying said processed update additional information data of said current radio broadcast.
